(19) United States
(12) Patent Application Publication
(10) Pub. No.: US 2023/0345862 A1
(43) Pub. Date: Nov. 2, 2023

(54) Metering Device for an Agricultural Machine

(71) Applicant: LEMKEN GmbH & Co. KG, Alpen (DE)

(72) Inventors: Christian GOTZEN, Viersen (DE); Dennis BERGERFURTH, Rees (DE); Bernd VALTWIES, Stadtlohn (DE)

(73) Assignee: LEMKEN GmbH & Co. KG, Alpen (DE)

(21) Appl. No.: 17/922,432

(22) PCT Filed: May 7, 2021
(86) PCT No.: PCT/DE2021/100421

§ 371 Date: Oct. 31, 2022

(30) Foreign Application Priority Data
May 8, 2020 (DE) 10 2020 002 763.6

(51) Int. Cl. A01C 15/00

(52) U.S. Cl. CPC A01C 15/007; A01C 15/003

(57) ABSTRACT

A metering device for an agricultural machine for outputting granular solids from at least one storage container to at least one dispensing unit by means of a conveyor system has a metering housing, and at least one inflow opening and at least one discharge opening for the granular solid. The metering housing forms a metering chamber on the inside. Between the metering chamber and the conveyor system a conveyor device rotating about a rotary axis is arranged. The conveyor device comprises at least one first rotary slide valve with at least one first opening for controlling the inflow and/or discharge of the granular solid into the or out of the conveyor device.

### TECHNICAL FIELD

The present invention relates to a metering device for an agricultural machine for outputting granular solids.

### BACKGROUND

Granular solids, for example in the form of seeds or fertilizer, are usually transported from a storage container to one or more dispensing units by means of a conveyer system. For this purpose, mechanical conveyer systems or frequently also pneumatic conveyer systems are employed, which convey the granular solid by means of a blower via connecting lines from the storage container, for example by way of a distribution device and a plurality of lines connected there, to the respective dispensing units. Feeding the granular solid from the storage container into the conveyer system is controlled by means of a metering device.

From EP 1570716 A2 a generic agricultural machine having a metering device for distributing a granular solid is known. This machine for distributing a granular solid comprises a metering device having one or more exchangeable cellular wheels. The cellular wheels are arranged in a housing. Following the removal of a bearing plate from a lateral opening, the respective cellular wheel arranged in the housing can be removed from the housing in the axial direction. Metering of the solid to be output takes place merely by way of the cellular wheel, wherein a change of the quantity to be output is merely possible by way of the rotary speed of the cellular wheels and by using different cellular wheels, for the purpose of which however an interruption of the work in process and an expensive removal of the installed cellular wheel and subsequent mounting of a new cellular wheel is required each time.

### SUMMARY

It is an object of the present disclosure to provide a metering device for an agricultural machine which makes possible a cost-effective production, an improved adjusting possibility and mounting of the metering device.

The object is solved through a metering device according to the features of independent claim. Advantageous embodiments of the invention are stated in the subclaims.

A metering device for an agricultural machine for outputting granular solids from at least one storage container to at least one dispensing unit by means of, in particular a pneumatic conveyer system includes a metering housing as well as at least one inflow opening and at least one discharge opening for the granular solid, wherein the metering device forms a metering chamber on the inside, wherein between metering chamber and the conveyer system a conveyor device rotating about a rotary axis is arranged. The conveyor device comprises at least one first rotary slide valve having at least one first opening for controlling the inflow and/or discharge of the granular solid into or from the conveyor device.

From the storage container, the granular solid can enter the metering housing and the metering chamber by gravity and the at least one inflow opening. Multiple granular solids can be fed into the metering chamber through additional inflow openings. The metering chamber, in particular on the bottom side, comprises a chamber opening which directly adjoins the conveyor device mounted in the metering housing, and through which the granular solid can enter the conveyor device by means of conveyor elements. A cross-section of the chamber opening that is effective for the inflow of the granular solid into the conveyor device can be adjusted by the, in particular first, rotary slide valve and in particular the first opening of the first rotary slide valve. By way of this, a quantity of granular solid flowing into the conveyor device can be adjusted. A quantity of the granular solid conveyed or metered by the conveyor unit can be additionally adjusted by a rotary speed of the conveyor unit and in particular by the conveyor elements employed. The conveyor elements can be cellular wheels of the same and/or different configuration arranged on the rotary axis adjacently to one another. The conveyor elements can be designed for the granular solids to be conveyed, wherein different conveyor elements can be charged with different solids through the rotary slide valve, for example by selective covering. The conveyor device can separate the at least one inflow opening and the at least one discharge opening from one another, in particular in a pressure-tight manner, which is advantageous in particular in the case of a pneumatic conveyor system. However, the conveyor system can also be employed combined with a mechanical conveyor system for granular solids. By using at least one first rotary slide valve, a cost-effective control of the supplied quantity of granular solid can be realised. In addition, the adjusting possibilities of the metering device can be improved through the configuration of the first rotary slide valve with the first opening. Because of the cylindrical basic shape of the metering device, the mounting of the metering device can be simplified since the same can be embodied for example so as to be pluggable.

In a preferred configuration, a rotary slide valve is designed and arranged in such a manner that the rotary slide valve can be moved rotationally and/or translationally about the and/or along the rotary axis of the conveyor device. A rotary slide valve can be of a tubular or half-shell configuration, as a result of which a cost-effective production can be made possible. An opening of the rotary slide valve can be formed in its lateral surface. By rotationally and/or translationally moving the rotary slide valve, an opening can be positioned differently relative to conveyor elements, as a result of which at least one defined solid or different solids can reach the conveying device.

In a particularly preferred configuration, the first rotary slide valve comprises a second opening which is located in particular substantially opposite the first opening. By way of the second opening the intended destination of the solid exiting the conveyor device can be adjusted for example on the conveyor system-side. Here, different openings of the metering device or, for example connecting lines of the conveyor system can be charged.

In a further configuration, an opening of a rotary slide valve comprises at least one rotary axis-parallel edge and/or profiled edge. The rotary axis-parallel or profiled edge can substantially extend along the rotary axis. A rotary axis-parallel edge makes possible, for example a trouble-free switching of an inflow opening or discharge opening. By way of a profiled edge, profiled for example in a wavy or jagged manner, a sequence pulsation in particular on the discharge side, i.e. no intermittent output, of the solid into the conveyor system can be avoided, since the metered solid does not leave the conveyor elements suddenly, but stretched over time.

In a particularly preferred configuration, an opening of a rotary slide valve comprises at least one edge that is arranged at an angle to the rotary axis and/or step-shaped in particular in the axial direction and/or circumferential direction. By way of an edge arranged at an angle or step-like, in particular in the axial direction of the rotary axis, individual or more metering elements can be closed or opened by corresponding rotational and/or translational moving of the rotary slide valve and thus of the opening concerned.

In a particularly preferred configuration, at least one second rotary slide valve having at least one opening is provided, wherein the rotary slide valves are arranged coaxially and in multiple tiers relative to one another. By way of a second rotary slide valve arranged coaxially and directly adjacently, a switching on the inflow side and/or discharge side can be realised which could be superimposed on a switching of the first rotary slide valve. The second rotary slide valve can comprise a third and a fourth opening, wherein the third opening can be arranged on the metering chamber-side and the fourth opening on the conveyor system-side for adjusting the direction in which the granular solid is to be dispensed from the metering device. Here, the third opening can be larger than the fourth opening since, for example regardless of the switching position of the fourth opening, sufficient granular solid is to reach the conveyor device through the third opening and the first rotary slide valve.

In a further particularly preferred configuration, the metering housing comprises on the conveyor system-side of the conveyor device a further discharge opening and/or a bypass opening. The further discharge opening can be arranged between the conveyor device and the conveyor system in order to make possible, for example connecting the metering device to a further connecting line. By way of this, a granular solid can be metered into a further connecting line or a second granular solid into a separate connecting line. The bypass opening can be arranged and formed in the metering housing, in particular on the conveyor device in such a manner that a granular solid is conveyed by the conveyor device out of the metering housing, without entering the conveyor system in the process. The bypass opening can be led out of the metering housing, in particular through a mounting flange, into the surroundings. By way of the bypass opening, a calibration test for calibrating the metered quantity of granular solid can be carried out. In addition, emptying of the metering device can be made possible without granular solid entering the conveyor system. The first discharge opening, the further discharge opening and/or the bypass opening can be opened or closed by way of a slide valve, in particular rotary slide valve.

Preferentially, a separating element and/or on the conveyor system-side of the conveyor device a separating device can be provided in the metering chamber. The separating element can separate the metering chamber into two regions, into which different solids can be introduced and supplied to the conveyor device. By way of slide valves or limiting elements, in particular by a rotary slide valve, solid material can be supplied to the conveyor device from a first part chamber and/or a second part chamber each, for example with a split metering chamber, wherein depending on the orientation of the separating element the solids can be conveyed with all or a part of the metering elements. The separating element can be mounted in the sub-bodies of the metering housing, and be arranged substantially parallel or at, in particular, a right angle to the rotary axis. The separating element can be formed in one piece or multiple parts, in particular each proportionally moulded-on in a sub-body. By way of the separating element, one or more solids can be supplied to the conveyor device without a time-consuming conversion or cleaning of the metering device being required.

The separating device can be arranged, in particular on the conveyor system-side, on the conveyor device between discharge openings and makes possible a separate metering of granular solids. The separating device can be designed as a flat element and arranged within at least one connecting line, wherein the separating device can reach as far as up to the conveyor device. The at least one discharge opening and/or bypass opening can be separated by way of the separating device in order to make possible a trouble-free conveying of the solids. The separating device can be arranged within a connecting line in order to form separate conveying paths.

In a further preferred configuration, at least one actuator is assigned to a rotary slide valve for the manual and/or motorised adjustment. By way of this, an individual adjustment of at least one rotary slide valve can be carried out. The mechanical adjustment of a rotary slide valve, for example by means of a lever makes possible a cost-effective and easily reproducible adjustment of the metering device. A motorised adjustment offers the advantage of a remote-controllable and/or automatic adjustment of the metering device.

According to a further configuration, the rotating conveyor device comprises a drive motor which rotary axis is arranged parallel, in particular coaxially to the rotary axis of the conveyor device. By way of the coaxial arrangement of the drive motor, the conveyor device can be driven substantially free of lateral forces and without torque offset. This offers the advantage of a less expensive and simpler more cost-effective design.

In a further preferred configuration of the metering device, the drive motor, further, is an actuator for at least one rotary slide valve. The at least one rotary slide valve can be connected via a switchable clutch device for adjusting the rotary slide valve. Here, conveying granular solid and/or adjusting at least one rotary slide valve can take place simultaneously and/or at different times. An advantage here is that the at least one rotary slide valve can be adjustable by remote control and/or automatically.

Preferentially, the rotary slide valve comprises a front wall and located opposite a receiving opening for receiving at least one conveyor element. The front wall can serve as stop for the conveyor elements received in the rotary slide valve and/or for fastening the drive motor or an actuator. The drive motor can be detachably connected to the rotary slide valve by way of grooves arranged radially on the outside, which partially extend along the circumference, as a result of which a compact and stable unit can be created, which makes possible a reliable operation of the conveyor device.

Further, the disclosure relates to an agricultural machine for outputting granular solids having, in particular, a pneumatic conveyor system for conveying the granular solids from a storage container to a number of dispensing units having at least one metering device, which is designed and further developed as described above.

In a preferred configuration of the agricultural machine, at least one sensor connected to an electronic evaluation system is provided on the dispensing unit-side of the metering device, by way of which a metered quantity of the granular solid can be detected and in particular the conveyor device controllable based on the detected quantity of the granular solid in order to regulate an output quantity of the metering device. The sensor can be arranged, for example on a, in particular each, connecting line or a, in particular each, line to a dispensing unit, as a result of which a reliable detection of the entire metered output quantity can be made possible.

In the following, the invention is explained in more detail by way of exemplary embodiments.

### BRIEF DESCRIPTION OF THE DRAWINGS

FIG. 1 shows an agricultural machine having a metering device in a schematic lateral view;

FIG. 2 shows a perspective, schematic view of a metering device;

FIG. 3 shows a schematic plan view of a metering device having a separating element;

FIG. 4 shows a perspective, schematic representation of a first rotary slide valve;

FIG. 5 shows a perspective, schematic representation of the conveyor device;

FIG. 6 shows a perspective lateral view of a metering device having a separating device;

FIG. 7 shows a perspective representation of the first rotary slide valve which is arranged coaxially within a second rotary slide valve; and

FIG. 8 shows a perspective, schematic view of the second rotary slide valve with an alternatively configured edge.

### DETAILED DESCRIPTION

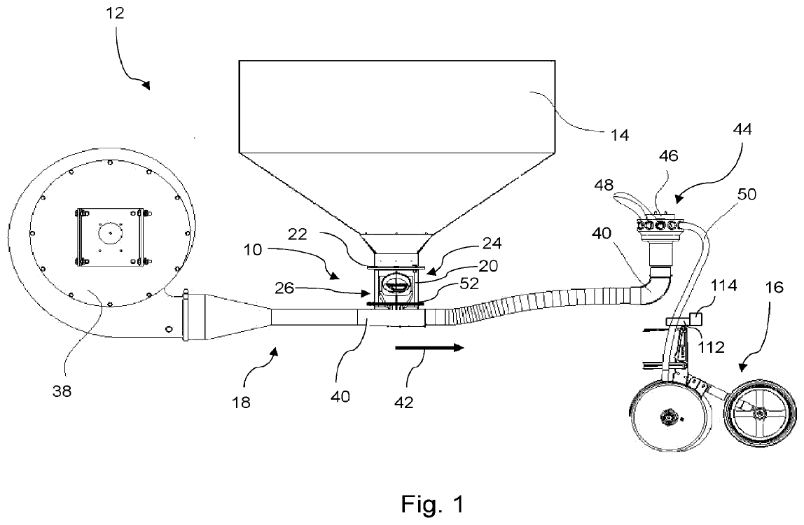

In FIG. 1, an agricultural machine 12 in the form of a seeding machine is shown in a schematic lateral view. At least one granular or powdery solid, for example in the form of seeds and/or fertilizer, is situated in a storage container 14. The granular solid is conveyed to at least one dispensing unit 16 by means of a mechanical or pneumatic conveyor system 18, where the granular solid can be introduced into the ground for example by coulters. The conveyor system 18 shown in FIG. 1 is a pneumatic conveyor system 18, in which the granular solid is conveyed in the conveying direction 42 through a connecting line 40 to at least one dispensing unit 16 by means of an air stream generated by a blower 38. For this purpose, the granular solid is conducted through a connecting line 40 to at least one distribution device 44, in which in a distribution chamber 46 a substantially uniform distribution of the granular solid over a number of valve openings 48 and lines 50 connected thereon takes place. The granular solid is conducted further through the lines 50 as far as the dispensing units 16. The dispensing units 16 can be for example seed coulters. The granular solid can be moved by the air stream with flow velocities of up to 30 m/s.

The granular solid is conveyed out of the storage container 14 into the conveyor system 18 by means of a metering device 10, wherein an accurate metering of the quantity of the conveyed solid takes place. The metering device 10 is arranged between the storage container 14 and the conveyor system 18, wherein in the agricultural machine 12 shown in FIG. 1 the granular solid is fed out of the storage container 14 to the metering device 10 substantially by gravity. For the supply of the granular solid, the metering device 10 comprises a metering housing 20 having at least one storage container-side inflow opening 24. The metered granular solid is dispensed into the conveyor system 18 through at least one discharge opening 26 arranged in the metering housing 20 on the conveyor system-side. For fastening to the storage container 14 and/or the conveyor system 18 on the storage container-side and/or conveyor system-side, the metering housing 20 comprises mounting flanges 22, 52.

The first mounting flange 22 on the storage container-side and the second mounting flange 52 on the conveyor system-side are of circular design. A configuration in the form of a polygon, in particular, having three or more than four corners would likewise be conceivable. By way of this, the metering device 10, based on the storage container 14 and/or the conveyor system 18, can be arranged turned in particular in steps or continuously. For regulating an output quantity of the metering device 10, the agricultural machine 12 comprises at least one sensor 112 connected to an electronic evaluation system 114 on the output unit-side of the metering device 10, by way of which a metered quantity of the granular solid can be detected and in particular the conveyor device 32 controlled based on the detected quantity of the granular solid.

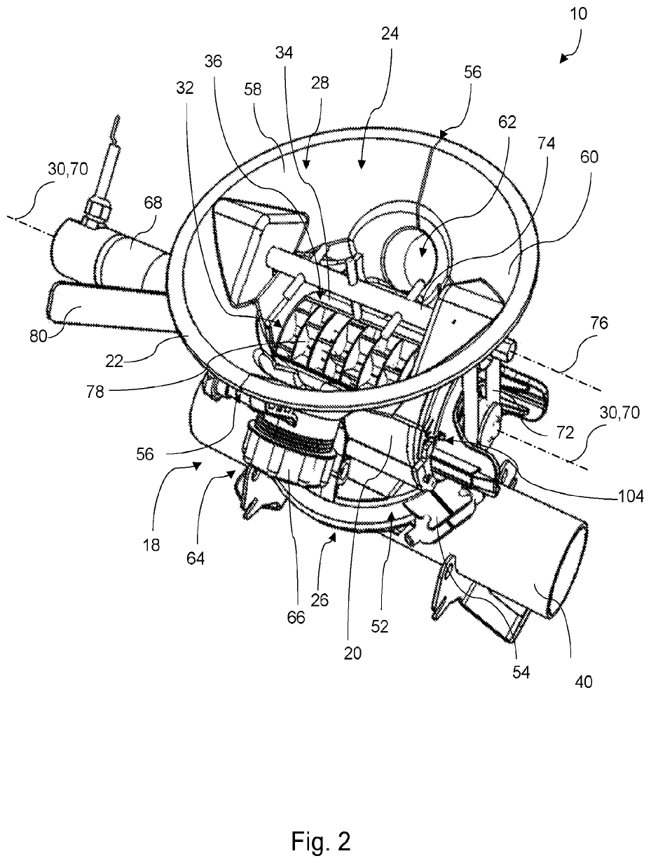

A perspective, schematic view of a metering device 10 is shown in FIG. 2. On its top side, the metering device 10 is shown to be not connected to the storage container, offering a view through the inflow opening 24 into the interior of the metering housing 20 and the metering chamber 28 formed by the said metering housing 20 on the inside. The inflow opening 24 is arranged within the circular first mounting flange 22 of the metering housing 20 and is enclosed by the same. On the bottom side, the metering housing 20 comprises the second mounting flange 52, which is likewise circular in design. The second mounting flange 52 encloses the first discharge opening 26 arranged within, through which the granular solid enters the conveyor system 18 and the connecting line 40. The second mounting flange 52 is detachably connected to the conveyor system 18 by way of a fastening means 54 in the form of a quick-release closure wrapping around the mounting flange 52.

On the metering chamber-side, the metering housing 20 comprises a first drain opening 62 and a second drain opening 64 located opposite the first drain opening 62, through which the granular solid can be drained out of the metering housing 20, for example in order to empty the metering chamber 28. The drain openings 62, 64 are closed by means of a drain plug 66 in the form of a cap that can be unscrewed. The drain openings 62, 64 are arranged in a separating plane 56 of the metering housing 20 designed in multiple parts. The metering housing 20 is embodied as a two-part housing and comprises a first sub-body 58 and a second sub-body 60. The sub-bodies 58 and 60 have the same, in particular identical, shape as a result of which the production costs can be lowered. Through the arrangement of the drain opening 62, 64 in the separating plane 56, these can be cost-effectively formed without expensive moulds with an external thread for receiving a drain plug 66. At the same time, the sub-bodies 58, 60 can be locked against relative movement on their separating plane 56 by the drain plugs 66.

Within the metering housing 20, a conveyor device 32 that can be rotated about a rotary axis 30 is arranged between the at least one inflow opening 24 and the at least one discharge opening 26 on the bottom side of the metering chamber 28. The conveyor device 32 comprises a number of conveyor elements 78 in the form of cellular wheels, which are arranged in the axial direction along the rotary axis 30 adjacent to one another. Upon a rotation of a conveyor device 32, granular solid is conveyed out of the metering chamber 28 through the at least one discharge opening 26 into the conveyor system 18. Metering of the granular solid takes place as a function of the mounted conveyor elements 78 and the rotational speed of the conveyor device 32. Here, the conveyor elements 78 can be configured identically or differently or be offset from one another in the pitch angle. Furthermore, the metering will be influenced by the quantity of granular solid supplied to the conveyor device 32. For this purpose, the conveyor device 32 comprises at least one first rotary slide valve 34 with at least one first opening 36 for controlling the inflow of the granular solid into the conveyor device 32. Also conceivable is a control of the discharge of the granular solid from the conveyor device 32. The first rotary slide valve 34 can be adjusted by means of an actuator 80, motorically or, as shown, by means of a manually actuatable lever.

The conveyor device 32 is motorically driven by means of, for example, an electric drive motor 68, which rotates about a rotation axis 70. The rotation axis 70 of the drive motor 68 is arranged coaxially to the rotary axis 30 of the conveyor device 32, as a result of which an efficient drive of the conveyor device 32 free of lateral forces is made possible. On the side of the metering housing 20 located opposite the drive motor 68, a drive for the agitator shaft 74 is arranged, which is rotatably mounted about an agitation axis 76 in the metering housing 20. By way of a connecting element 72, the agitation axis 76 is operatively connected to the rotary axis 30, as a result of which upon a rotary movement of the rotary axis 30 a rotary movement of the agitation axis 76 takes place. The term axis is likewise used to describe the respective shaft as mechanical component. The connecting element 72 can be configured in the form of one or multiple gearwheels or, as shown in FIG. 2, in the form of a belt drive. By way of the connecting element 72, a transmission ratio between the rotary speeds of the rotary axis 30 and the agitation axis 76 can be additionally established.

The conveyor elements 78 of the conveyor device 32 can be axially slid onto the rotary axis 30, in particular into the first rotary slide valve 34. Interlocking the conveyor device 32 with the metering device 20 or a rotary slide valve 34 can take place by means of a bayonet closure 104, which is attached or moulded onto the metering housing 20 on the outside. In the case of a bayonet closure, at least one, preferentially multiple, radially projecting positive locking elements are positioned axially relative to one another on the respective components to be connected each other and secured against disconnection by twisting against each other.

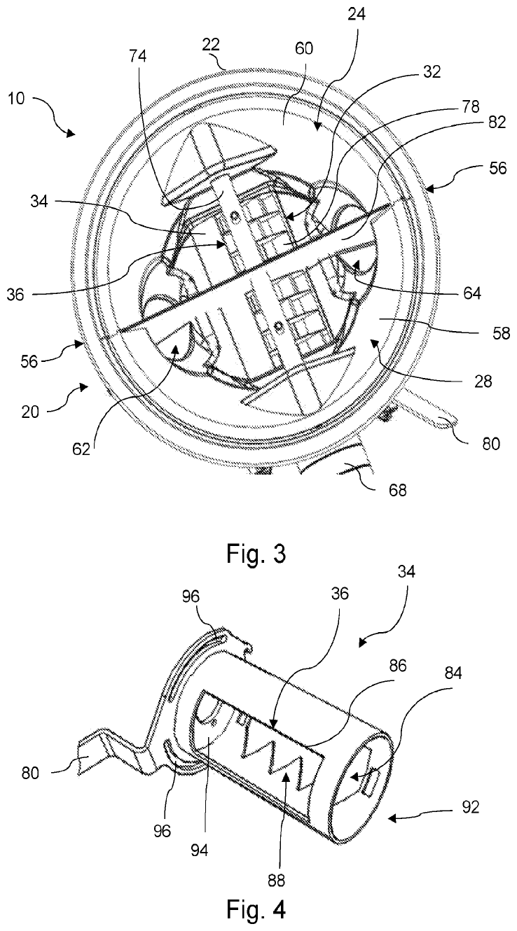

A schematic plan view of a metering device 10 having a separating element 82 arranged within the metering chamber is shown in FIG. 3. Between the first sub-body 58 and the second sub-body 60, the two-part metering housing 20 comprises the separating plane 56. In the separating plane 56, the separating element 82 is arranged within the metering chamber 28, which separating plane 82 separates the metering chambering 28 substantially into two-part chambers of identical size. This makes possible metering a different granular solid in each part chamber, for example through a respective separate inflow opening 24. Here, the separating element 82 can separate the inflow opening 24 into two inflow openings. Because of the arrangement and configuration of the first and second drain opening 62, 64 in the separating plane 56, the drain openings 62, 64 are likewise separated by the separating element 82, so that a separate drain of the granular solid out of the part chambers is possible. The agitating shaft 74 penetrates the separating element 82 so that the solid can be loosened up on both sides of the separating element 82. By way of a suitable configuration of the first opening 36 of the first rotary slide valve 36, a separate or joint metering of the granular solid out of the part chambers is possible.

The first rotary slide valve is shown in detail in FIG. 4. The rotary slide valve 34 is substantially designed in the form of a pipe portion having a first opening 36 cut out of the lateral surface. Upon a rotation of the rotary slide valve 34, a cross-section of an opening of the metering chamber on the conveyor device-side can be enlarged or reduced by the lateral surface of the rotary slide valve, in particular with the at least one first opening 36, as a result of which a supply of granular solid into the conveyor device can be controlled. The first opening 36 comprises in the axial direction two rotary axis-parallel edges 86, as a result of which a substantially unhindered inflow of granular solid into the conveyor device can be brought about. In the lateral surface of the first rotary slide valve 34, a second opening 84 located opposite the first opening 36 is arranged. The second opening 84 in a mounted state of the rotary slide valve 34 is assigned to at least one discharge opening. Along the rotary axis, the second opening 84 comprises at least one profiled edge 88, wherein profiling is designed in jagged form. By way of this profiled edge 88, a pulsating dispensation of metered granular solid can be avoided on the discharge side.

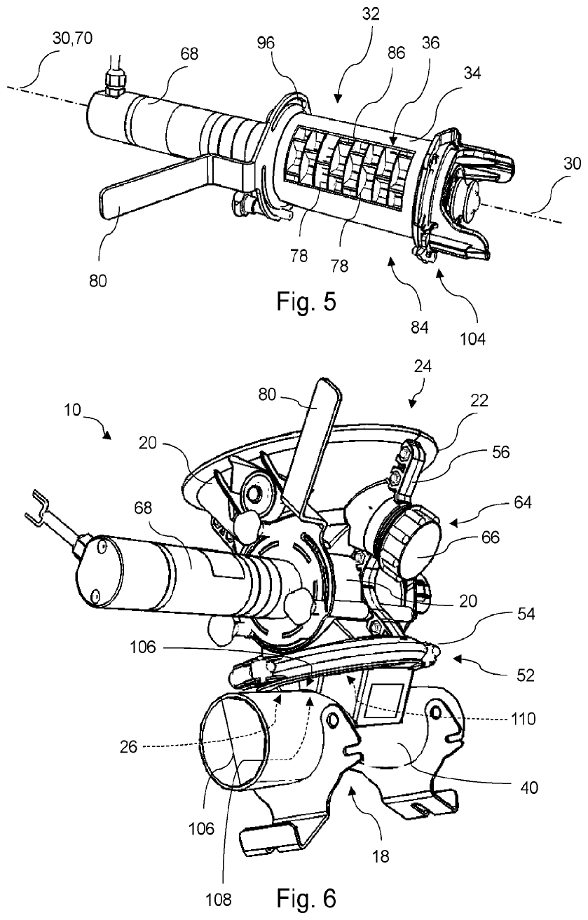

For receiving conveyor elements, the first rotary slide valve 34 comprises a receiving opening 92. Located opposite the receiving opening 92, the first rotary slide valve 34 is at least partially closed by a front wall 94 which also serves as stop for the received conveyor elements. The front wall 94 extends in the radial direction beyond the circumference of the rotary slide valve 34 (FIG. 5) and comprises on the outside a manually actuatable actuator 80 for adjusting the first rotary slide valve 34. Radially on the outside, slots and further openings running in the circumferential direction are additionally arranged, which serve for the fastening of the drive motor 68 to the first rotary slide valve 34 and/or the fastening and rotary fixing of the rotary slide valve 34 to the metering housing 20 (FIG. 2). Here, the drive motor 68 is arranged with its rotation axis 70 coaxially to the rotary axis 30 of the conveyor device 32. The conveyor elements 78 are arranged within the first rotary slide valve 34 as in a cassette and are held on the side of the receiving opening 92 by a partly U-shaped cover which as bayonet closure can be connected to the metering housing 20 and be locked by a rotary movement about the rotary axis 30.

The metering device 10 shown in FIG. 6 comprises a separating device 106 on the conveyor system-side, which separates the first discharge opening 26 from a second discharge opening 108 of the metering housing 20. This makes possible on the conveyor system-side a targeted metering of a granular solid into the first and/or second discharge opening 26, 108. The separating device 106 extends from the conveyor device 32 as far as into the conveyor system 18 and into the connecting line 40, as a result of which the connecting line 40 is divided by the separating device 106 on the inside and a part is assigned to each discharge opening 26, 108. Furthermore, the metering device 10 comprises a bypass opening 110 in the metering housing 20, which bypass opening 110 is arranged on a side of the conveyor device 32 located opposite the metering chamber 28. The bypass opening is arranged in the metering housing 20 next to the discharge openings 26, 108 and makes possible conveying granular solid out of the metering device 28 by the conveyor device 32, for example into the surroundings in order to perform a calibration test, or empty the metering chamber 28.

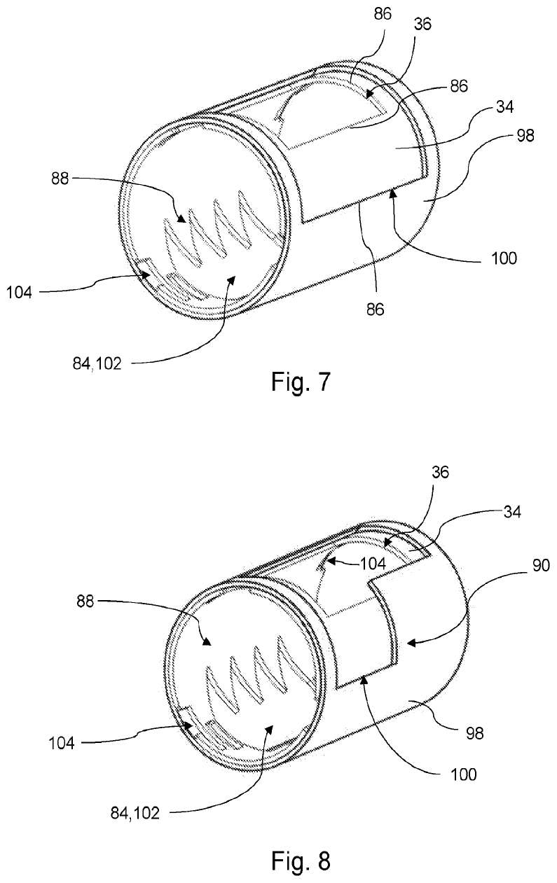

Switching the first discharge opening 26, the second discharge opening 108 and/or the bypass opening 110, can take place by means of a further, for example a second rotary slide valve 98, which is shown in FIG. 7. The second rotary slide valve 98 is arranged coaxially and radially adjacently relative to the first rotary slide valve 34, in particular in a contacting manner. Here, the first rotary slide valve 34 is arranged within the second rotary slide valve 98. The first rotary slide valve 34 comprises the first opening 36 with at least one rotary axis-parallel edge 86 for controlling the supplied quantity of granular solid into the conveyor device 32. The shock-free dispensation of the metered solid into the at least one discharge opening (not shown) takes place by way of the second opening 84 with a profiled edge 88. Controlling whether the metered granular solid is dispenses into the first discharge opening, the second discharge opening and/or the bypass opening is effected, for example via the second rotary slide valve 98. For this purpose, the second rotary slide valve 98 has a third opening 100 on the inflow side, which makes possible an unhindered inflow of the solid substantially regardless of the rotary position. Located opposite the third opening 100, a fourth opening 102 is formed in the lateral surface of the second rotary slide valve 98. The fourth opening 102 can likewise comprise rotary axis-parallel edges (not shown) and serves for controlling the dispensation of the metered solid into the respectively selected opening. The third opening 100 has a larger cross-section than the fourth opening 102, since through the third opening 100, in each position of the fourth opening 102, the unhindered inflow of granular solid into the conveyor device is to be ensured.

An alternatively configured form of the second rotary slide valve 98 is shown in FIG. 8. The third opening 100 of the second rotary slide valve 98 on the inflow side has a step-shaped edge 90 along the rotary axis. By way of this, the lateral surface of the second rotary slide valve 98 viewed in the axial direction is cut out to different extents. This makes possible, for example in the case of a metering chamber divided by a separating element 82 (FIG. 3) a simultaneous or optional supply of granular solid from the respective part chambers into the conveyor device. The quantity of granular solid supplied into the conveyor device can, furthermore, be controlled by the first rotary slide valve 34 and its first opening 36.

A further rotary slide valve can be provided spaced apart coaxially and in the radial direction from the first and/or second rotary slide valve 34, 98 within the metering housing 20. This further rotary slide valve can be a tubular configuration, wherein for example only a part of its lateral surface can be formed and/or arranged within the metering housing 20, in particular the metering chamber 28. A further rotary slide valve can be arranged with a portion of its lateral surface between the conveyor device 32 and the at least one agitator shaft 74. By way of this, the further rotary slide valve can reduce a pressure of the granular solid on the conveyor device 32, as a result of which clogging in the metering chamber 28 can be avoided and supplying the granular solid to the conveyor device 32 improved.

As used in this application, the term “or” is intended to mean an inclusive “or” rather than an exclusive “or”. That is, “A or B” refers to any of “A alone,” “B alone,” and “both A and B” unless specified otherwise or clear from context. The articles “a” and “an” as used in this application should generally be construed to mean “one or more” unless specified otherwise or clear from context to be directed to a singular form.

### REFERENCE NUMBERS

| | |
|---|---|
| 10 | Metering device |
| 12 | Agricultural machine |
| 14 | Storage container |
| 16 | Dispensing unit |
| 18 | Conveyor system |
| 20 | Metering housing |
| 22 | First mounting flange |
| 24 | Inflow opening |
| 26 | Discharge opening |
| 28 | Metering chamber |
| 30 | Rotary axis |
| 32 | Conveyor device |
| 34 | First rotary slide valve |
| 36 | First opening |
| 38 | Blower |
| 40 | Connecting line |
| 42 | Conveyor device |
| 44 | Distributor device |
| 46 | Distribution chamber |
| 48 | Distribution opening |
| 50 | Line |
| 52 | Second mounting flange |
| 54 | Fastening means |
| 56 | Separating plane |
| 58 | First sub-body |
| 60 | Second sub-body |
| 62 | First drain opening |
| 64 | Second drain opening |
| 66 | Drain plug |
| 68 | Drive motor |
| 70 | Rotation axis |
| 72 | Connecting element |
| 74 | Agitator shaft |
| 76 | Agitation axis |
| 78 | Conveyor element |
| 80 | Actuator |
| 82 | Separating element |
| 84 | Second opening |
| 86 | Rotary axis-parallel edge |
| 88 | Profiled edge |
| 90 | Step-shaped edge |
| 92 | Receiving opening |
| 94 | Front wall |
| 96 | Slot |
| 98 | Second rotary slide valve |
| 100 | Third opening |
| 102 | Fourth opening |
| 104 | Bayonet closure |
| 106 | Separating device |
| 108 | Second discharge opening |
| 110 | Bypass opening |
| 112 | Sensor |
| 114 | Electronic evaluation system |

1.-14. (canceled)

15. A metering device (10) for an agricultural machine (12) for outputting granular solids from a storage container (14) to a dispensing unit (16) by a conveyor system (18), comprising:
a metering housing (20);
a metering chamber (28) formed inside the metering housing (20);
an inflow opening (24) for the granular solids;
a discharge opening (26) for the granular solids; and
a conveyor device (32) rotating about a rotary axis (30) arranged between the metering chamber (28) and the conveyor system (18),
wherein the conveyor device (32) comprises a first rotary slide valve (34) having a first opening (36) for controlling an inflow or discharge of the granular solids into or out of the conveyor device (32).

16. The metering device according to claim 15,
wherein the first rotary slide valve (34) is designed and arranged such that the first rotary slide valve (34) can be moved rotationally about or translationally along the rotary axis (30) of the conveyor device (32).

17. The metering device according to claim 15,
wherein the first rotary slide valve (34) comprises a second opening (84) which is substantially located opposite the first opening (36).

18. The metering device according to claim 15,
wherein the first opening (36) of the first rotary slide valve (34) comprises a rotary axis-parallel edge (86) or a profiled edge (88).

19. The metering device according to claim 15,
wherein the opening (36) of the first rotary slide valve (34) comprises an edge (90) that is arranged at an angle to the rotary axis (30) or step-shaped in an axial direction or circumferential direction.

20. The metering device according to claim 15, further comprising
a second rotary slide valve (98) having a second opening (100, 102),
wherein the first rotary slide valve (34) and the second rotary slide valve (98) are arranged coaxially and in multiple tiers relative to one another.

21. The metering device according to claim 15,
wherein the metering housing (20) comprises a further discharge opening (108) or a bypass opening (110) on a conveyor system-side of the conveyor device (18).

22. The metering device according to claim 15,
wherein a separating element (82) or, on a conveyor system-side of the conveyor device (18), a separating device (106) is provided in the metering chamber (28).

23. The metering device according to claim 15,
wherein an actuator (80) is assigned to the first rotary slide valve (34, 98) for manual or motorised adjustment.

24. The metering device according to claim 15,
wherein the conveyor device (32) comprises a drive motor (68) having a rotation axis (70) that is arranged parallel to the rotary axis (30) of the conveyor device (32).

25. The metering device according to claim 24,
wherein the drive motor (68) is an actuator for the first rotary slide valve (34).

26. The metering device according to claim 15,
wherein the first rotary slide valve (34) comprises
a front wall (94) and
a receiving opening (92) for receiving a conveyor element (78) located opposite.

27. An agricultural machine for outputting granular solids, comprising:
a pneumatic conveyor system (18) for conveying the granular solids out of a storage container (14) to a plurality of dispensing units (16); and
the metering device (10) according to claim 15.

28. The agricultural machine according to claim 27,
wherein, on a dispensing unit-side of the metering device (10), at least one sensor (112) connected to an electronic evaluation system (114) is provided, through which a metered quantity of the granular solids can be detected, and
wherein the conveyor device (32) can be controlled based on the metered quantity of the granular solids in order to regulate an output quantity of the metering device (10).
